(19) United States
(12) Patent Application Publication
(10) Pub. No.: US 2026/0203549 A1
(43) Pub. Date: Jul. 16, 2026

(54) ECOLOGICAL ENVIRONMENT CORRELATION ANALYSIS METHOD AND SYSTEM BASED ON GRAPH NEURAL NETWORK

(71) Applicant: ANQING NORMAL UNIVERSITY, Anqing City (CN)

(72) Inventors: Axiu SHU, Anqing City (CN); Chunyan GUI, Anqing City (CN); Xiaojuan XIE, Anqing City (CN)

(73) Assignee: ANQING NORMAL UNIVERSITY, Anqing City (CN)

(21) Appl. No.: 19/072,596

(22) Filed: Mar. 6, 2025

Related U.S. Application Data
(63) Continuation of application No. PCT/CN2025/073472, filed on Jan. 21, 2025.

(30) Foreign Application Priority Data
Jan. 10, 2025 (CN) 202510039943.3

(51) Int. Cl. G06N 3/042

(52) U.S. Cl. CPC G06N 3/042

(57) ABSTRACT

The disclosure relates to the technical field of environmental analysis, in particular to an ecological environment correlation analysis method and system based on graph neural network, the method includes: obtaining ecological environment data; inputting the ecological environment data into a preset heterogeneous graph neural network model to obtain an association mode of the ecological environment data, where, the heterogeneous graph neural network model is constructed based on graph convolution neural network, the heterogeneous graph neural network model is used to extract vertices information, edges information and spatio-temporal dependency from the ecological environmental data, and determines key vertices and associated paths based on the vertices information, edges information and spatio-temporal dependency, so as to obtain the associated mode of the ecological environmental data.

### CROSS-REFERENCE TO RELATED APPLICATIONS

This application is a continuation of PCT/CN 2025/073472, filed on Jan. 21, 2025, which claims priority to Chinese Patent Application No. 202510039943.3, filed on Jan. 10, 2025 the contents of which are hereby incorporated by reference.

### TECHNICAL FIELD

The disclosure relates to the technical field of environmental analysis, in particular to an ecological environment correlation analysis method and system based on graph neural network.

### BACKGROUND

In the correlation analysis of ecological environment, how to effectively use graph neural network model for feature extraction and association mining is facing many technical challenges. Firstly, ecological environment data is highly heterogeneous and dynamic, and different types of vertices and edges contain different information, and the date changes with time. This requires that the graph neural network model is able to deal with different types of vertices and edges flexibly and adapt to the dynamic network structure. Secondly, ecological environmental correlation has the characteristics of multi-scale and multi-level, including both local interaction and global synergy. Graph neural network model needs to be able to capture the association patterns at different scales and levels at the same time, and carry out effective fusion. Furthermore, the ecological environmental correlation is often time-space dependent, and the correlation state at a certain point in time will be affected by the historical state, and the correlation intensity between different regions is also different. How to introduce spatio-temporal factors into graph neural network model and model spatio-temporal dependence is an urgent problem to be solved. Finally, interpretiveness is also an aspect that may not be ignored in the correlation analysis of ecological environment. It is difficult to directly guide decision-making by the results of simple correlation analysis, and the mechanism behind the correlation model needs to be explained. However, the existing graph neural network models are mostly black box models, which are lack of interpretability. How to design an interpretable graph neural network model to make the analysis results more transparent and credible is a direction worth exploring. Therefore, the disclosure provides an ecological environment correlation analysis method and system based on graph neural network.

### SUMMARY

The purpose of the disclosure is to provide an ecological environment correlation analysis method and system based on graph neural network, which may effectively mine complex correlation patterns in ecological environment data, provide support for ecological environment monitoring, early warning and decision-making, and have important theoretical significance and disclosure value.

To achieve the above objectives, the present disclosure provides the following scheme:
an ecological environment correlation analysis method based on graph neural network includes:
obtaining ecological environment data;
inputting the ecological environment data into a preset heterogeneous graph neural network model to obtain an association mode of the ecological environment data, where, the heterogeneous graph neural network model is constructed based on graph convolution neural network, the heterogeneous graph neural network model is used to extract vertices information, edges information and spatio-temporal dependency from the ecological environmental data, and determines key vertices and associated paths based on the vertices information, edges information and spatio-temporal dependency, so as to obtain the associated mode of the ecological environmental data.

Optionally, the heterogeneous graph neural network model includes: a heterogeneous graph construction unit, a spatio-temporal attention unit, an association feature extraction unit, and an association pattern analysis unit, where the heterogeneous graph construction unit is used for constructing a vertex embedding vector, an edges embedding vector and a heterogeneous graph based on the ecological environment data; the spatio-temporal attention unit is used for performing time series coding and spatial position coding on the ecological environment data to obtain a spatio-temporal dependency; the related feature extraction unit is used for extracting multi-level related features based on the heterogeneous graph and the spatio-temporal dependency; the association pattern analysis unit is used to calculate the association strength between vertices based on the association characteristics, and determine the association pattern based on the association strength.

Optionally, the heterogeneous graph construction unit constructs an embedding vector and an edges embedding vector of a vertices based on the ecological environment data, including:
constructing a vertices embedding matrix and an edges embedding matrix based on the ecological environment data; and
respectively mapping the vertices embedding matrix and the edges embedding matrix to low-dimensional space through an embedding layer to obtain the vertices embedding vector and the edges embedding vector.

Optionally, the spatio-temporal attention unit performs time series coding and spatial position coding on the ecological environment data, and obtaining the spatio-temporal dependency including:
extracting time series information and spatial position information in the ecological environment data;
encoding the time series information by adopting a time embedding layer to obtain a time embedding vector;
encoding the spatial position information by adopting a spatial embedding layer to obtain a spatial embedding vector;
fusing the temporal embedding vector and the spatial embedding vector to obtain a spatio-temporal embedding representation;
according to the spatio-temporal embedding representation, calculating the attention weights between different spatio-temporal points through the spatio-temporal attention mechanism; and
based on the attention weight, the spatio-temporal embedded representations of different spatio-temporal points are weighted and aggregated to construct the spatio-temporal dependency.

Optionally, the associated extraction unit based on the heterogeneous graph and spatio-temporal dependency extracts multi-level associated features including:
encoding a multi-scale graph convolution algorithm, and by setting convolution kernels with different sizes, extracting features of the heterogeneous graph and the spatio-temporal dependency to obtain local correlation features and global correlation features; and
encoding a graph pooling algorithm to fuse the local correlation features and the global correlation features to obtain multi-level correlation features.

Optionally, the association pattern analysis unit calculates the association strength between vertices based on the association characteristics, and determining the association pattern based on the association strength includes:
calculating the similarity between embedded vectors of vertices corresponding to the associated features, and taking the similarity as a measure value of the associated strength;
ordering the association relationship between vertices based on the correlation strength measurement value to determine key vertices; and
taking the key vertices as the starting point, connecting other vertices based on the correlation strength measurement value, determining the correlation path, and obtaining the correlation mode.

Optionally, the heterogeneous graph neural network model further includes a post-processing module, the post-processing module is used for processing the data according to the rules of the ecological environment field, filtering and optimizing the association pattern, removing redundant and invalid association patterns, and obtaining the final association pattern.

To further achieve the above object, the disclosure also provides an ecological environment correlation analysis system based on graph neural network, the system includes: an environmental data acquisition module, an environmental data analysis module, where, the environmental data acquisition module is used for acquiring ecological environment data; the environmental data analysis module is used for inputting the ecological environment data into a preset heterogeneous graph neural network model, acquiring an association mode of the ecological environment data, where, the heterogeneous graph neural network model is constructed based on graph convolution neural network, the heterogeneous graph neural network model is used to extract vertices information, edges information and spatio-temporal dependency from the ecological environmental data, and determine key vertices and associated paths based on the vertices information, edges information and spatio-temporal dependency, so as to obtain the associated mode of the ecological environmental data.

The disclosure has the beneficial effects that:

According to the characteristics of heterogeneity, spatio-temporal dependence and the like of ecological environment data, the disclosure constructs a heterogeneous graph neural network model, adopts multi-scale graph convolution and graph pooling algorithms to extract multi-level association patterns, and introduces a spatio-temporal attention mechanism to model spatio-temporal dependence, on this basis, the disclosure designs an association measurement algorithm based on graph neural network, calculates the association strength between vertices, and optimizes the association mode by adopting a post-processing method based on rules. The disclosure is able to effectively mine complex association patterns in ecological environment data, provide support for ecological environment monitoring, early warning and decision-making, and has important theoretical significance and application value.

### BRIEF DESCRIPTION OF THE DRAWINGS

For more clearly explain the technical scheme in the embodiment of the disclosure or in the prior art, the drawings needed in the embodiment will be briefly introduced below, obviously, the drawings in the following description are only some embodiments of the disclosure, and other drawings may be obtained according to these drawings without creative work for ordinary people in the field.

FIG. 1 is a flowchart of an ecological environment correlation analysis method based on graph neural network according to an embodiment of the disclosure.

### DETAILED DESCRIPTION OF THE EMBODIMENTS

In the following, the technical scheme in the embodiment of the disclosure will be described clearly and completely with the attached drawings, obviously, the described embodiment is only a part of the embodiment of the present disclosure, not the whole embodiment. Based on the embodiments in the present disclosure, all other embodiments obtained by ordinary technicians in the field without creative labor belong to the scope of protection of the present disclosure.

In order to make the above objects, features and advantages of the present disclosure more obvious and easy to understand, the present disclosure will be further described in detail with the attached drawings and specific embodiments.

Ecological environmental correlation analysis usually includes: (1) identifying the relationship between environmental factors: analyzing the interaction between different environmental factors (such as climate change, water quality, land use, etc.); (2) assessing the impact of environmental change: predicting the impact of environmental change on ecosystems (such as species diversity, water resources, soil health, etc.) through data analysis; (3) supporting environmental decision-making: providing scientific basis for the government and relevant decision-makers to help them make more scientific environmental management decisions; (4) optimizing ecological restoration and protection measures: providing data support for ecological protection and restoration, and optimizing the effects of policies and measures.

### Graph Neural Network

Graph neural network (GNN) is a kind of neural network model for processing graph structure data. Graph data is a structure composed of vertices and edges, in which vertices represent entities and edges represent relationships between vertices. In many practical disclosures, data may be represented as graphs in essence. The basic idea of graph neural network is to learn the embedding of vertices through the information transmission between vertices and their neighbors. GNN updates the state (or characteristics) of each vertex by iteration, thus aggregating the information of its neighbors, and then obtaining the high-level representation of vertices in the graph.

A typical calculation process of GNN includes the following steps:
vertices feature initialization: each vertex in the graph has an initial feature vector. These features may be attributes of vertices (such as user information in social networks) or embedded representations obtained through pre-training.

Neighbor information aggregation: each vertex updates its own feature representation at each layer by aggregating the features of its neighbors (such as weighted average, maximum or sum, etc.). Common polymerization methods include sum, average and maximum.

Vertices feature update: according to its aggregated neighbor information and its current characteristics, vertices use neural networks (such as full connection layer, activation function, etc.) to update their feature representation.

Multilayer iteration: the above process is usually repeated many times to form a multi-layer graph neural network structure. At each layer, the representation of vertices will gradually contain more and more neighbor information.

Output layer: the final vertices representation is able to be used for vertex classification, graph classification, link prediction and other tasks.

Graph neural network (GNN) is an important branch of deep learning, which is specially used to process graph structure data. It is able to effectively capture the relationship information between vertices and their neighbors in the graph through information transmission and aggregation between vertices. With the continuous development of graph neural network, more and more variants and improved methods (such as GCN, GAT, GraphSAGE, etc.) appear, which enables GNN to achieve excellent application results in many fields (such as social networks, chemical molecules, recommendation systems, etc.).

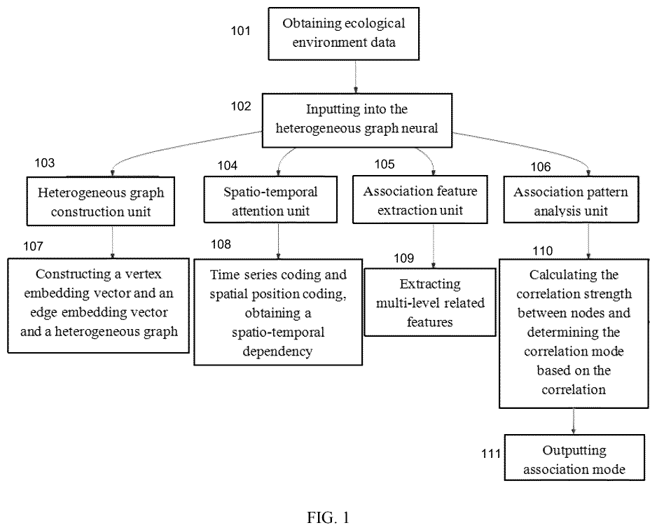

Based on the above, this embodiment provides an ecological environment correlation analysis method based on graph neural network, as shown in FIG. 1, which includes:
Block 101—obtaining ecological environment data;
Block 102—inputting the ecological environment data into a preset heterogeneous graph neural network model to obtain an association mode of the ecological environment data, where, the heterogeneous graph neural network model is constructed based on graph convolution neural network, the heterogeneous graph neural network model is used to extract vertices information, edges information and spatio-temporal dependency from the ecological environmental data, and determines key vertices and associated paths based on the vertices information, edges information and spatio-temporal dependency, so as to obtain the associated mode of the ecological environmental data.

Specifically, in this embodiment, a heterogeneous graph neural network model is constructed aiming to the characteristics of heterogeneity and spatio-temporal dependence of ecological environment data, multi-level association patterns are extracted by using multi-scale graph convolution and graph pooling algorithms, and spatio-temporal attention mechanism is introduced to model spatio-temporal dependence, on this basis, the disclosure designs an association measurement algorithm based on graph neural network, calculates the association strength between vertices, and optimizes the association mode by adopting a post-processing method based on rules. The method may effectively mine complex association patterns in ecological environment data, provide support for ecological environment monitoring, early warning and decision-making, and has important theoretical significance and application value.

Further, the heterogeneous graph neural network model includes: a heterogeneous graph construction unit 103, a spatio-temporal attention unit 104, an association feature extraction unit 105, and an association pattern analysis unit 106, where the heterogeneous graph construction unit is used for constructing a vertex embedding vector, an edge embedding vector and a heterogeneous graph based on the ecological environment data at 107; the spatio-temporal attention unit is used for performing time series coding and spatial position coding on the ecological environment data to obtain a spatio-temporal dependency at 108; the association feature extraction unit is used for extracting multi-level related features based on the heterogeneous graph and the spatio-temporal dependency at 109; the association pattern analysis unit is used to calculate the association strength between vertices based on the association characteristics, and determine the association pattern based on the association strength at 110.

Further, the heterogeneous graph construction unit constructs an embedding vector and an edges embedding vector of a vertices based on the ecological environment data, including: constructing a vertices embedding matrix and an edges embedding matrix based on the ecological environment data; and respectively mapping the vertices embedding matrix and the edges embedding matrix to a low-dimensional space through an embedding layer to obtain the vertices embedding vector and the edges embedding vector.

Further, the spatio-temporal attention unit performs time series coding and spatial position coding on the ecological environment data, and obtaining the spatio-temporal dependency including: extracting time series information and spatial position information in the ecological environment data; encoding the time series information by adopting a time embedding layer to obtain a time embedding vector; encoding the spatial position information by adopting a spatial embedding layer to obtain a spatial embedding vector; fusing the temporal embedding vector and the spatial embedding vector to obtain a spatio-temporal embedding representation; according to the spatio-temporal embedding representation, calculating the attention weights between different spatio-temporal points through the spatio-temporal attention mechanism; and based on the attention weight, the spatio-temporal embedded representations of different spatio-temporal points are weighted and aggregated to construct the spatio-temporal dependency.

Specifically, in this embodiment, when processing complex spatio-temporal data, it is necessary to simultaneously consider the information of time and space dimensions, firstly, obtaining time series information and spatial position information, the time series information may be the data of each vertex at different time points, and the spatial position information includes the latitude and longitude coordinates of each vertex. The function of time embedding layer is to transform discrete time points into continuous vector representation. For example, you may use sine and cosine functions to encode time and map 24 hours a day to vectors in high-dimensional space. This may capture the periodic characteristics of time. The spatial embedding layer transforms the geographical location information of vertices into vector representation, and the two-dimensional coordinates may be mapped to high-dimensional space by grid coding or learning method. This helps the model to understand the spatial relationship between vertices. The fusion of spatio-temporal embedded representations may be achieved through simple splicing or more complex attention mechanisms. The fused representation integrates the information of time and space, which provides rich features for subsequent modeling. The core idea of spatio-temporal attention mechanism is to let the model automatically learn the importance weights between different spatio-temporal points. Attention weights may be obtained by calculating the similarity between query vectors and key vectors, and then normalized by softmax function. The weighted aggregation process will sum the features of different time and space points according to the attention weight. This step realizes the selective transmission of information, which enables the model to capture complex spatio-temporal dependencies.

Further, the associated extraction unit based on the heterogeneous graph and spatio-temporal dependency extracts multi-level associated features including: encoding a multi-scale graph convolution algorithm, and by setting convolution kernels with different sizes, extracting features of the heterogeneous graph and the spatio-temporal dependency to obtain local correlation features and global correlation features; and encoding a graph pooling algorithm to fuse the local correlation features and the global correlation features to obtain multi-level correlation features.

Further, the association pattern analysis unit calculates the association strength between vertices based on the association characteristics, and determining the association pattern based on the association strength includes: calculating the similarity between embedded vectors of vertices corresponding to the associated features, and taking the similarity as a measure value of the associated strength; ordering the association relationship between vertices based on the correlation strength measurement value to determine key vertices; and taking the key vertices as the starting point, connecting other vertices based on the correlation strength measurement value, determining the correlation path, and obtaining the correlation mode.

Specifically, the cosine similarity is used to calculate the correlation strength between vertices. Suppose there are two vertices A and B, and their vector representations are [0.2,0.5, −0.1,0.8] and [0.1,0.6, −0.2,0.7] respectively, the calculated cosine similarity is 0.98, which indicates that the interest similarity between the two users is very high. In this way, the key vertices with strong correlation may be found. Starting from the key vertices, people may trace the edges with strong correlation strength, determine the correlation path and form the correlation mode.

Further, the heterogeneous graph neural network model further includes a post-processing module, the post-processing module is used for processing the data according to the rules of the ecological environment field, filtering and optimizing the association pattern, removing redundant and invalid association patterns, and obtaining the final association pattern.

Specifically, in this embodiment, according to the expert knowledge and experience in the field of ecological environment, a set of post-processing rule base based on rules is established to optimize and screen the association patterns. The optimized screening is as follows:
the initial association pattern results obtained by the association metric algorithm are obtained as input data for post-processing optimization. Traverse each association pattern, and judge whether the association pattern is redundant or invalid according to the rule conditions in the post-processing rule base. If the current association pattern meets any rule in the rule base, it will be marked as redundant or invalid association and removed from the association result set. For the remaining effective association patterns, the association rules mining algorithm is adopted to further refine and summarize the higher-level association rules. Combined with the knowledge of domain experts, the mined high-level association rules are manually reviewed and confirmed to remove the associations that do not meet the characteristics of ecological environment. The optimized association patterns and association rules are output at 111 as the final association analysis results for subsequent ecological environment application and decision-making.

For example, the rule base in this embodiment contains rules such as “the correlation strength between water quality indicators and meteorological conditions should not exceed the threshold”. For example, if a correlation model shows that the correlation between PM2.5 concentration and wind speed is as high as 0.9, it may be an abnormal correlation that needs further examination. After obtaining the initial association pattern results, the system will check each association pattern one by one. Assuming that there is a correlation model that shows that “the discharge of industrial wastewater is positively correlated with the number of fish in nearby rivers”, this obviously violates ecological common sense and should be marked as invalid correlation and eliminated. For the retained effective association patterns, people may apply Apriori and other association rule mining algorithms for in-depth analysis. For example, by analyzing the environmental data of several cities, people may find a high-level association rule that “when the area of industrial park increases by 10% and the greening rate decreases by 5%, the probability of air quality index increasing by 8% is 75%”. In the manual audit stage, environmental experts will review these automatically generated rules. For example, a rule may indicate that “wetland area is negatively correlated with bird diversity”, which is contrary to ecological theory and experts will eliminate it. On the contrary, the rule that “urban green space rate is positively correlated with residents'happiness” may be retained because it conforms to the research findings of environmental psychology. The final output of correlation analysis results may include specific correlation models such as “within 10 kilometers around the industrial park, the average annual concentration of PM 2.5 will decrease by 2 μg/m³ for every additional air quality monitoring station”.

As another preferred embodiment, this method introduces semi-supervised learning method into the training of the constructed heterogeneous graph neural network model.

Specifically, the semi-supervised learning method is used to deal with the problem of sparse ecological environmental data labels. Through vertex reconstruction and edge reconstruction, the self-monitoring task of unlabeled data is constructed, and the implicit feature representation of data is obtained by self-monitoring learning. The tag information obtained by semi-supervised learning and the feature representation obtained by self-supervised learning are fused to optimize the similarity calculation method in the association measurement algorithm. According to the optimized similarity calculation method, the correlation analysis of ecological environment data is carried out, and the internal relations and laws between the data are mined. Based on the results of correlation analysis, the tag information of data with sparse tags is expanded by tag completion and inference. Data enhancement and regularization techniques are introduced to improve the robustness of the model, reduce the risk of over-fitting, and enhance the applicability of the model in actual ecological environment data.

By combining machine learning with expert knowledge, people may understand the complex ecological environment system more comprehensively and accurately, and provide strong support for formulating scientific environmental protection strategies. The results of correlation analysis are able to help decision makers find the best balance between economic development and environmental protection and realize sustainable development.

To further optimize the technical scheme, the embodiment also provides an ecological environment correlation analysis system based on graph neural network, the system includes: an environmental data acquisition module, an environmental data analysis module, where, the environmental data acquisition module is used for acquiring ecological environment data; the environmental data analysis module is used for inputting the ecological environment data into a preset heterogeneous graph neural network model, acquiring an association mode of the ecological environment data, where, the heterogeneous graph neural network model is constructed based on graph convolution neural network, the heterogeneous graph neural network model is used to extract vertices information, edges information and spatio-temporal dependency from the ecological environmental data, and determine key vertices and associated paths based on the vertices information, edges information and spatio-temporal dependency, so as to obtain the associated mode of the ecological environmental data.

Further, the heterogeneous graph neural network model includes: a heterogeneous graph construction unit, a spatio-temporal attention unit, an association feature extraction unit, and an association pattern analysis unit, where the heterogeneous graph construction unit is used for constructing a vertices embedding vector and an edge embedding vector based on the ecological environment data to construct a heterogeneous graph; the spatio-temporal attention unit is used for performing time series coding and spatial position coding on the ecological environment data to obtain a spatio-temporal dependency; the related feature extraction unit is used for extracting multi-level related features based on the heterogeneous graph and the spatio-temporal dependency; the association pattern analysis unit is used to calculate the association strength between vertices based on the association characteristics, and determine the association pattern based on the association strength.

Further, the heterogeneous graph construction unit constructs an embedding vector and an edges embedding vector of a vertices based on the ecological environment data, including: constructing a vertices embedding matrix and an edges embedding matrix based on the ecological environment data; and respectively mapping the vertices embedding matrix and the edges embedding matrix to a low-dimensional space through an embedding layer to obtain the vertices embedding vector and the edges embedding vector.

Further, the spatio-temporal attention unit performs time series coding and spatial position coding on the ecological environment data, and obtaining the spatio-temporal dependency including: extracting time series information and spatial position information in the ecological environment data; encoding the time series information by adopting a time embedding layer to obtain a time embedding vector; encoding the spatial position information by adopting a spatial embedding layer to obtain a spatial embedding vector; fusing the temporal embedding vector and the spatial embedding vector to obtain a spatio-temporal embedding representation; according to the spatio-temporal embedding representation, calculating the attention weights between different spatio-temporal points through the spatio-temporal attention mechanism; and based on the attention weight, the spatio-temporal embedded representations of different spatio-temporal points are weighted and aggregated to construct the spatio-temporal dependency.

Further, the associated extraction unit based on the heterogeneous graph and spatio-temporal dependency extracts multi-level associated features including: encoding a multi-scale graph convolution algorithm, and by setting convolution kernels with different sizes, extracting features of the heterogeneous graph and the spatio-temporal dependency to obtain local correlation features and global correlation features; and encoding a graph pooling algorithm to fuse the local correlation features and the global correlation features to obtain multi-level correlation features.

Further, the association pattern analysis unit calculates the association strength between vertices based on the association characteristics, and determining the association pattern based on the association strength includes: calculating the similarity between embedded vectors of vertices corresponding to the associated features, and taking the similarity as a measure value of the associated strength; ordering the association relationship between vertices based on the correlation strength measurement value to determine key vertices; and taking the key vertices as the starting point, connecting other vertices based on the correlation strength measurement value, determining the correlation path, and obtaining the correlation mode.

Further, the heterogeneous graph neural network model further includes a post-processing module, the post-processing module is used for processing the data according to the rules of the ecological environment field, filtering and optimizing the association pattern, removing redundant and invalid association patterns, and obtaining the final association pattern.

The above mentioned embodiment is only a description of the preferred mode of the disclosure, and does not limit the scope of the disclosure. Under the premise of not departing from the design spirit of the disclosure, various modifications and improvements made by ordinary technicians in the field to the technical scheme of the disclosure shall fall within the protection scope determined by the claims of the disclosure.

What is claimed is:

1. An ecological environment correlation analysis method based on graph neural network, wherein the method comprises:
obtaining ecological environment data;
inputting the ecological environment data into a preset heterogeneous graph neural network model to obtain an association mode of the ecological environment data, wherein, the heterogeneous graph neural network model is constructed based on graph convolution neural network, the heterogeneous graph neural network model is used to extract vertices information, edges information and spatio-temporal dependency from the ecological environment data, and determines key vertices and associated paths based on the vertices information, edges information and spatio-temporal dependency, so as to obtain the associated mode of the ecological environment data.

2. The ecological environment correlation analysis method based on graph neural network according to claim 1, wherein the heterogeneous graph neural network model comprises: a heterogeneous graph construction unit, a spatio-temporal attention unit, an association feature extraction unit, and an association pattern analysis unit, wherein the heterogeneous graph construction unit is used for constructing a vertices embedding vector, an edge embedding vector and a heterogeneous graph based on the ecological environment data; the spatio-temporal attention unit is used for performing time series coding and spatial position coding on the ecological environment data to obtain a spatio-temporal dependency; the association feature extraction unit is used for extracting multi-level related features based on the heterogeneous graph and the spatio-temporal dependency; the association pattern analysis unit is used to calculate an association strength between vertices based on association characteristics, and determine the association pattern based on the association strength.

3. The ecological environment correlation analysis method based on graph neural network according to claim 2, wherein the heterogeneous graph construction unit constructs an embedding vector and an edges embedding vector of a vertices based on the ecological environment data, comprising:
constructing a vertices embedding matrix and an edges embedding matrix based on the ecological environment data; and
respectively mapping the vertices embedding matrix and the edges embedding matrix to a low-dimensional space through an embedding layer to obtain the vertices embedding vector and the edges embedding vector.

4. The ecological environment correlation analysis method based on graph neural network according to claim 2, wherein the spatio-temporal attention unit performs time series coding and spatial position coding on the ecological environment data, and obtaining the spatio-temporal dependency comprising:
extracting time series information and spatial position information in the ecological environment data;
encoding the time series information by adopting a time embedding layer to obtain a temporal embedding vector;
encoding the spatial position information by adopting a spatial embedding layer to obtain a spatial embedding vector;
fusing the temporal embedding vector and the spatial embedding vector to obtain a spatio-temporal embedding representation;
according to the spatio-temporal embedding representation, calculating attention weights between different spatio-temporal points through a spatio-temporal attention mechanism; and
based on the attention weights, the spatio-temporal embedded representations of different spatio-temporal points are weighted and aggregated to construct the spatio-temporal dependency.

5. The ecological environment correlation analysis method based on graph neural network according to claim 2, wherein the associated extraction unit based on the heterogeneous graph and spatio-temporal dependency extracts multi-level associated features comprising:
encoding a multi-scale graph convolution algorithm, and by setting convolution kernels with different sizes, extracting features of the heterogeneous graph and the spatio-temporal dependency to obtain local correlation features and global correlation features; and
encoding a graph pooling algorithm to fuse the local correlation features and the global correlation features to obtain multi-level correlation features.

6. The ecological environment correlation analysis method based on graph neural network according to claim 2, wherein the association pattern analysis unit calculates the association strength between vertices based on the association characteristics, and determining the association pattern based on the association strength comprises:
calculating a similarity between embedded vectors of vertices corresponding to the associated features, and taking the similarity as a measure value of the associated strength;
ordering an association relationship between vertices based on the correlation strength measurement value to determine key vertices; and
taking the key vertices as a starting point, connecting other vertices based on the correlation strength measurement value, determining the correlation path, and obtaining the correlation mode.

7. The ecological environment correlation analysis method based on graph neural network according to claim 2, wherein the heterogeneous graph neural network model further comprises a post-processing module, the post-processing module is used for processing the data according to rules of an ecological environment field, filtering and optimizing the association pattern, removing redundant and invalid association patterns, and obtaining a final association pattern.

8. An ecological environment correlation analysis system based on graph neural network, wherein the system comprises: an environmental data acquisition module, an environmental data analysis module, wherein, the environmental data acquisition module is used for acquiring ecological environment data; the environmental data analysis module is used for inputting the ecological environment data into a preset heterogeneous graph neural network model, acquiring an association mode of the ecological environment data, wherein, the heterogeneous graph neural network model is constructed based on graph convolution neural network, the heterogeneous graph neural network model is used to extract vertices information, edges information and spatio-temporal dependency from the ecological environmental data, and determine key vertices and associated paths based on the vertices information, edges information and spatio-temporal dependency, so as to obtain the associated mode of the ecological environmental data.
